(19) United States
(12) Patent Application Publication
(10) Pub. No.: US 2008/0310777 A1
(43) Pub. Date: Dec. 18, 2008

(54) Sliding bearing having sintered layer formed of sintered segments

(75) Inventors: Seong Hee Kim, Incheon (KR); Won Ho Choi, Seoul (KR)

Correspondence Address: STAAS & HALSEY LLP, SUITE 700, 1201 NEW YORK AVENUE, N.W., WASHINGTON, DC, 20005, US

(73) Assignee: S.O.B. CO., LTD., Incheon (KR)

(21) Appl. No.: 11/812,071

(22) Filed: Jun. 14, 2007

(51) Int. Cl. F16C 33/10

(52) U.S. Cl. 384/13

(57) ABSTRACT

Disclosed is a sliding bearing having a sintered layer formed of sintered segments on a sliding side surface of a steel base member, the sintered layer being made of iron group metal powder and solid lubricant and being formed by forcibly compressing the sintered segments, each of which is molded by previously sintering mixtures made of the iron group metal powder and the solid lubricant into a size enough to construct a portion of the whole sintered layer, on the sliding side surface of the steel base member to form the whole sintered layer, and sintering-bonding the sintered segments to each other and also each of the sintered segments to the steel base member.

### BACKGROUND OF THE INVENTION

1. Field of the Invention

The present invention relates to a sliding bearing having a sintered layer formed of sintered segments, and more particularly, to a sliding bearing having a sintered layer formed of sintered segments on a steel base member, in such a fashion that the sintered layer is formed by bonding a plurality of sintered segments, each of which is previously sintering-molded by sintering materials consisting essentially of iron group metal powder and solid lubricant, on a sliding side surface of the steel base member.

2. Background of the Related Art

In general, the sliding bearing is a mechanical element made by forming an overlay layer, which is made of any one material selected from an iron group alloy, a copper group alloy, an aluminum alloy, a copper-lead group alloy, a synthetic resin composite material, and the like, on the steel base member or on a surface contacting with the iron group sintered layer, and is used as a supporting portion or a sliding portion and the like of a journal, a guide, and a reciprocating device in a vehicle, an injection mold, a heavy utility, a press, a machine tool, an industrial machine, and the like, and is sorted into a bush type (cylindrical type, semi-cylindrical type) sliding bearing and a flat board type sliding bearing.

Among the sliding bearings as described above, the present invention relates particularly to a steel based sliding bearing having iron group sintered segments, which is made by forming an overlay lay (sintered layer) consisting of the iron group metal powder and the solid lubricant on the sliding side surface of the steel base member, so that it can endure the high load.

Conventionally, the steel based sliding bearing having iron group sintered segments is generally made by cold-compressing sintering material, which is obtained by mixing powder or granular body of iron group metal powder (which is obtained by mixing copper powder with the iron group powder, and other metal powders such as nickel, zinc, and the like is selectively mixed) and the solid lubricant (such as graphite, molybdenum disulfide (MoS₂), and tungsten sulfate (WS₂), and the like) to produce cold-compressed molding body for constituting the whole sintered layer by means of a press or a rolling roller, and the like, and then the cold-compressed molding bodies are charged into a sintering furnace and sintered at high temperature under the gas atmosphere thereby making the whole sintered layer at the same time. In this instance, the whole sintered layer is bonded to the steel base member during the sintering.

However, according to the conventional method for fabricating the steel based sliding bearing having iron group sintered segments, which comprises cold-compressing sintering material constructed of the iron group metal powder and the solid lubricant on the surface of the steel base member into cold-compressed molding body constituting the whole sintered layer, and charging and sintering the cold-compressed molding bodies, there have been caused following problems to be solved.

At first, when the size (volume, length of the lubrication surface, and area of the lubrication surface) of the sliding bearing was big, it was difficult to obtain delicate and uniform cold-compressed molding body, even if it was compressed at very high pressure, if the sintering material constructed of the iron group metal powder and the solid lubricant was instantly compressed on the surface of the steel base member thereby making the cold-compressed molding body.

In other words, it was difficult to make the density of the cold-compressed molding body having more than any predetermined volume or length, uniform and dense entirely by the high pressure compression.

This was because the sintering material was made of powdery metal having very big hardness and strength, and the voids between the respective metal powders are distributed irregularly. Thus, when the cold-compressed molding body was made to have reduced delicacy and in-equal density, the sintered layer became to be reduced in delicacy partially and in-equal in density, so that the load-resistant property and the wear resistant property should be reduced. Also, a very long time was required to fabricate the cold-compressed molding body and the productivity of the sliding bearing was greatly reduced due to high ratio of the inferior products.

Next, when the size of the sintered layer of the sliding bearing was big, if the sintering material (the iron group metal powder and the solid lubricant) for forming the whole sintered layer was compressed into a molding body, resulting in the cold-compressed molding body having a big size, the shrinkage and the deformation were greatly caused during the sintering, so that there caused a problem that it was difficult to obtain the sintered layer having a good precision degree of the size and shape. This was because the shrinkage became great in proportion as the volume or length of the cold-compressed molding body when it was sintered at one time, while the whole shrinkage was produced during the melting and densification of the metal powder of low melting point such as copper and the like, in the process of the sintering.

Especially, since the temperature of the respective inside portion of the cold-compressed molding body was maintained to be uniform, and the density of the sintering material was not equal, the melting amount and melting degree of the metal powder of low melting point was made to be different at every portion to make the amount of the shrinkage different, resulting in the change of the original shape of the cold-compressed molding body, and difficulty in obtaining the sintered layer having a precise shape.

Next, when the sintered layer was formed by compressing the sintering materials for forming the whole sintered layer at one time to thereby produce the cold-compressed molding body corresponding to the whole sintered layer, and sintering it, since various kinds of cold-compressed molding molds were required according to the volume of the sintered layer, the length of the lubrication surface and the area of the lubrication surface, it was difficult to provide sliding bearings conforming to the various size requirements from the consumers of the sliding bearings.

### SUMMARY OF THE INVENTION

Therefore, the present invention has been made in an attempt to to solve such conventional problems, and an object of the present invention is to provide a sliding bearing, in which the whole sintered metal structure of the sintered layer is dense and uniform, when the sintered layer having a big size (volume, length of the lubrication surface, area of the lubrication surface) is formed on the steel base member.

Another object of the present invention is to provide a sliding bearing having a good precision degree of the size and shape of the sintered layer, even if the sintered layer having a big size is formed on the steel base member.

Another object of the present invention is to provide a sliding bearing, which can be produced quickly and easily to cope with the various size requirements instantly at low production cost.

To accomplish the above objects, according to the present invention, there is provided a sliding bearing having a sintered layer formed of sintered segments on a sliding side surface of a steel base member, the sintered layer being made of iron group metal powder and solid lubricant and being formed by forcibly compressing the sintered segments, each of which is molded by previously sintering mixtures made of the iron group metal powder and the solid lubricant into a size enough to construct a portion of the whole sintered layer, on the sliding side surface of the steel base member to form the whole sintered layer, and sintering-bonding the sintered segments to each other and also each of the sintered segments to the steel base member.

The iron group metal powder constituting the sintered segment is made by uniformly mixing 10 to 50 wt % of copper powder, 0.1 to 30 wt % of one or more than two metal powders selected from nickel, titanium, silicon, cobalt, chromium, manganese, or tin, and remaining iron powder by using a mixer.

Especially, when the iron powder having a size below 250 meshes is used, it is possible to densify the sintering metal structure of the sintered layer and improve the bonding property at the time of sintering-bonding the sintered layer to the steel base member.

The containing amount of copper powder in the sintered segment is not much restricted, and it can be applied selectively within a range of 10 to 50 wt % according to the densification degree of the required sintered metal structure.

When the copper containing amount is below 10 wt %, the densification degree of the sintered metal is reduced, and when it exceeds 50 wt %, the iron group metal particle in the sintered metal is completely surrounded by the copper particle so that it becomes impossible to exhibit original strength characteristic and friction characteristic of the iron group sintering material.

When 0.5 to 30 wt % of one or more than two metal powders selected from metals such as nickel, titanium, silicon, aluminum, cobalt, chromium, manganese, or tin is added to the iron group metal powder, it is possible to obtain high load-resistant property and improve the bonding property between the sintered segment and the steel base member at the time of sintering-bonding the sintered segment to the steel base member.

In addition, it is possible to add 2 to 20 wt % of one or more than two metal powders selected from the metals such as zinc, lead, tin, tungsten, and molybdenum to the iron group metal powder so as to reduce the iron-bonding property with respect to the subject material and improve the lubrication property.

The sold lubricant constituting the sintered segment is mixed uniformly with the iron group metal powder as powder form, and it is preferable to use one or more than two solid lubricants selected from graphite, molybdenum disulfide (MoS₂), or tungsten sulfate (WS₂).

The containing amount of the solid lubricant can be selectively applied within a range of 0.1 wt % to 20 wt % with respect to the iron group metal powder according to the use of the sliding bearing.

Since the sintered segment of the present invention is to be molded in a small size, it doesn't act as material for hindering the sintering in the course of the sintering, although relatively large amount of the solid lubricant is contained.

The sintered segment is molded by mixing the iron group metal powder with the solid lubricant, and then cold-compressing the obtained mixture into a shape of sintered segment, and sintering the resultant object at the inside of a sintering furnace.

In this instance, as to the sintering method, any one sintering method can be selected from a solid phase sintering (sintering temperature is from 600° C. to 1065° C.), a transition sintering (sintering temperature is from 1065° C. to 1095° C.), and a liquid phase sintering (sintering temperature is above 1095° C.). Especially, in case of the solid phase sintering, it is preferable to fill the sintering materials into a mold for molding the sintered segment and pressurizing to sinter the obtained object at the inside of the sintering furnace by means of compression means.

The sliding bearing according to the present invention can be fabricated into the bush type sliding bearing and the flat board type sliding bearing.

### BRIEF DESCRIPTION OF THE DRAWINGS

The above and other objects, features and advantages of the present invention will be apparent from the following detailed description of the preferred embodiments of the present invention in conjunction with the accompanying drawings, in which:

FIG. 1a through FIG. 1f show a bush type sliding bearing and a fabricating method thereof according to a first embodiment of the present invention;

FIG. 2a and FIG. 2b are a cross-sectional view of the bush type sliding bearing according to a second embodiment of the present invention, and a perspective view of a steel base member used in the fabrication thereof;

FIG. 3a through FIG. 3c show a bush type sliding bearing and a fabricating method thereof according to a third embodiment of the present invention;

FIG. 4a through FIG. 4d show a flat-board type sliding bearing and a fabricating method thereof according to a fourth embodiment of the present invention;

FIG. 5 is a perspective view of the steel base member used in the fabrication of the flat board type sliding bearing according to a fifth embodiment of the present invention; and

FIG. 6a through FIG. 6e show a flat board type sliding bearing and a fabricating method thereof according to a sixth embodiment of the present invention.

### DETAILED DESCRIPTION OF THE PREFERRED EMBODIMENT

Hereinafter, the preferred embodiments of the sliding bearing having a sintered layer using sintered segments according to the present invention will be described in detail with reference to the appended drawings.

### FIRST EXAMPLE

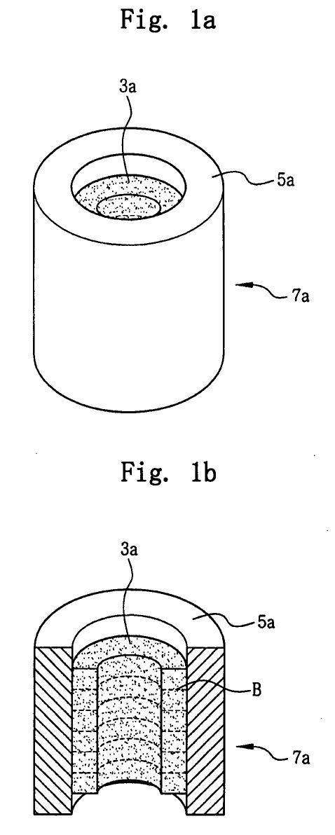

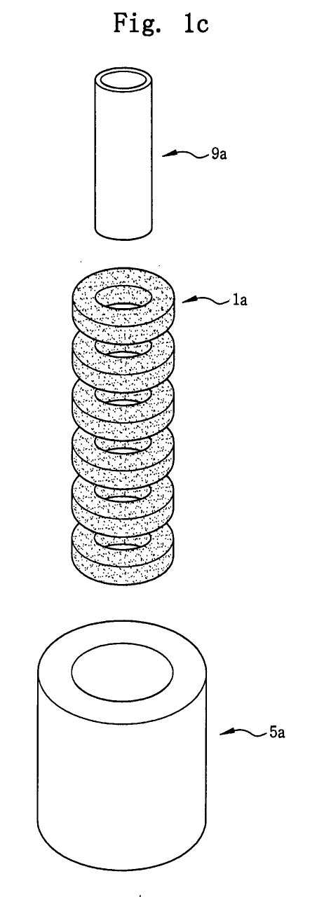

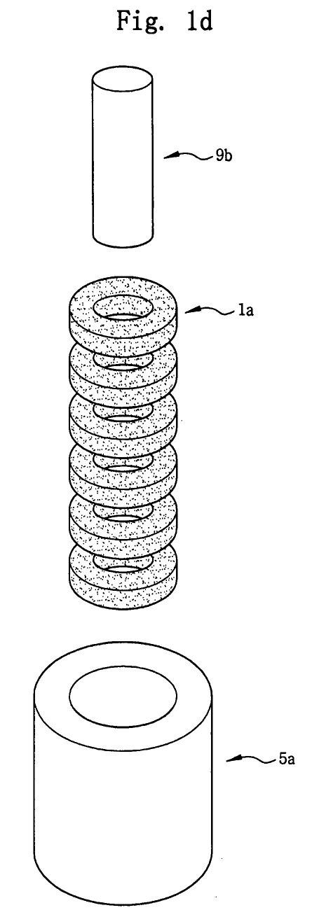

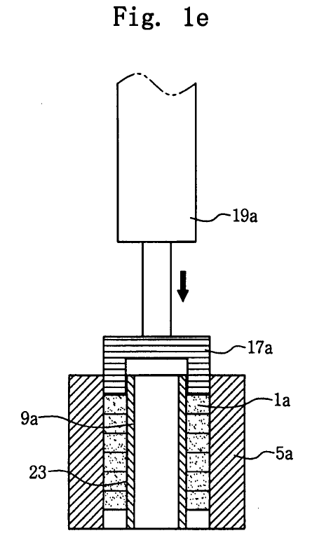

FIG. 1a through FIG. 1f show a bush type sliding bearing and a fabricating method thereof according to a first embodiment of the present invention.

Concretely, FIG. 1a is a perspective view of a bush type sliding bearing according to a first embodiment of the present invention, FIG. 1b is a cross-sectional view of the bush type sliding bearing shown in FIG. 1a, FIG. 1c is a separated perspective view showing a round metal pipe, a sintered segment, and a steel base member used in the fabrication of the bush type sliding bearing according to a first embodiment, FIG. 1d is a separated perspective view showing a round metal rod, a sintered segment, and a steel base member used in the fabrication of the bush type sliding bearing according to a first embodiment, FIG. 1e is a cross-sectional view showing a method of assembling the round metal pipe, the sintered segment, and the steel base member shown in FIG. 1c, and FIG. 1f is a cross-sectional view schematically showing a method for pressurizing and bonding-sintering the sintered segment and the steel base member by the expansion of the round tube in a sintering furnace.

Referring now to FIG. 1c through FIG. 1f, the characteristic of the present invention resides in that a small sintered segment for constituting a portion of the whole sintered layer 3a is molded by sintering (primary sintering) using sintering material formed by mixing iron group metal powder with solid lubricant, a desired number of sintered segments 1a are chosen to conform to a size of the whole sintered layer 3a intended to be molded and pressure-fitted on the sliding side surface of the steel base member 5a, and then sintered again to thereby bond the sintered segments 1a to each other and concurrently bond the respective sintered segments 1a to the steel base member 5a.

In other words, the characteristics of the present invention does not reside in that a cold-compressed molding body conforming to the whole sintered layer is molded on the sliding side surface of the steel base member 5a and is sintered at one time to thereby form the whole sintered layer, but it resides in that a small sintered segment 1a for constituting a portion of the whole sintered layer is previously molded by sintering (primary sintering) using sintering material formed by mixing iron group metal powder with solid lubricant, a desired number of sintered segment 1a is forcibly compressed so that it can be contacted with the sliding side surface of the steel base member 5a, and then secondarily sintered again to thereby bond the sintered segments 1a to each other and concurrently bond the respective sintered segments 1a to the steel base member 5a, resulting in the formation of the sintered layer 3a on the sliding side surface of the steel base member 5a.

As the size of the sintered segment 1a is made to be very small in comparison with the whole sintered layer 3a, it is possible to mold by sintering the structure thereof very dense and uniform, as well as increase the precision degree of the size and shape. As a result, the structure of the whole sintered layer 3a, which is formed by sintering-bonding the sintered segments 1a, becomes to be very dense and uniform, and also the size and shape of the sintered layer becomes very precise. It is possible to easily permeate the oil into a bonded surface B between the sintered segments, if it is required, since there are lots of grooves at the bonded surface B.

Also it is possible for the supplier of the sliding bearing, who receives demands of various sizes, to previously mass produce sintered segments 1a of a predetermined standard, and then bond the sintered segments 1a to thereby complete the sliding bearing with a sintered layer 3a having a size conforming to the requirement of the demander by only secondary sintering-bonding it and instantly supply it to the demander.

Referring to FIG. 1c through FIG. 1f, hereinafter, a method for fabricating the bush type sliding bearing according to the first embodiment of the present invention will be described.

In the fabrication of the bush type sliding bearing according to the first embodiment of the present invention, a ring type sintered segment 1a for constituting a portion of the whole sintered layer 3a is at first molded by sintering materials constructed of the iron group metal powder and the solid lubricant (primary sintering). Then, a desired number of the sintered segment 1a is chosen to conform to the size of the whole sintered layer to be formed, and pressed-fitted on the sliding side surface of the cylindrical steel base member 5a.

In this instance, a cylindrical metal tube (shown by numeral 9a in FIG. 1c) or a metal rod (shown by numeral 9b in FIG. 1d), which is closely contacted with the inner peripheral surface of the sintered segment 1a, is inserted into the inner peripheral surface of the ring type sintered segment 1a by using a release agent 23 so that an outer peripheral surface of the ring type sintered segment 1a can be well bonded to an inner peripheral surface of the steel base member 5a to thereby enable the metal tube 9a or the metal rod 9b be thermally expanded in the course of the sintering.

Thus, when the metal tube 9a or the metal rod 9b is thermally expanded in the course of sintering-bonding (secondary sintering) with close contacted with the inside surface of the sintered segment 1a, the sintered segment 1a is forcibly pressed to the steel base member 5a to thereby complete the firm bonding between the outer peripheral surface of the sintered segment 1a and the inner peripheral surface of the steel base member 5a.

As regard to the metal tube 9a or the metal rod 9b, it is preferable to use a stainless steel tube or a stainless steel rod (a heat expansion ratio of a stainless steel is 1.9/° C.), which has a big heat expansion ratio and is not melted at the bonding temperature (600° C.˜1100° C.), however, it is not necessarily restricted to this material. The metal tube 9a or the metal rod 9b should have round section of a proper diameter so that it can be close contacted with the inside of the ring type sintered segment 1a.

Hereinafter, only the case of using the metal tube 9a is illustratively described.

The release agent 23 is required to easily separate the metal tube 9a or the metal rod 9b from the sintered segment la after the sintering-bonding. Well-known release agents such as silicon resin, wax, carbon powder, and the like can be used as the release agent 23.

As regard to the material for the cylindrical steel base member 5a, cast iron steel, carbon steel, stainless steel, and the like can be used, because they have a high strength and a hardness and can be easily sintering-bonded with the iron group metal.

Referring to FIG. 1e, prior to the charging into the sintering furnace 15 for the sintering-bonding, the sintered segment 1a is inserted between the cylindrical steel base member 5a and the metal tube 9a, and then it is pressed and stacked on the outer peripheral surface of the steel base member by means of a puncher 17a, and the like, which is operated by a press 19a. In this instance, as shown in FIG. 1f, an assembly of the steel base member 5a, the sintered segment 1a, and the metal tube 9a is disposed at the inside of the sintering furnace 15, and the inside temperature of the sintering furnace 15 is raised to 600° C.˜1100° C. by using a heater 21 disposed in the sintering furnace 15 to thereby perform the secondary sintering of the sintered segment 1a. The sintering time can be chosen appropriately within a range of 5 to 10 minutes.

During the sintering, since the metal tube 9a is thermally expanded to press the sintered segment 1a to the steel base member 5a, and also the inside wall of the steel base member 5a is thermally expanded, the sintered segment 1a and the steel base member 5a can be closely bonded to each other.

As a result, the sintered segment 1a and the steel base member 5a can be well sintering-bonded.

Referring to FIG. 1b, according to the bush type sliding bearing 7a fabricated through the above process, it is possible to form an integral type sintered layer 3a by bonding the sintered segments 1a to each other, and also the sintered layer 3a is firmly bonded to the steel base member 5a, so that the sintered layer 3a is prevented from the separation even if a big load has been applied for a longtime.

In addition, it is easy to permeate the lubrication oil, and the like to the bonded surface B, since a pore layer (shown by a dotted line) is formed at the bonded surface B between the respective sintered segments 1a.

### SECOND EXAMPLE

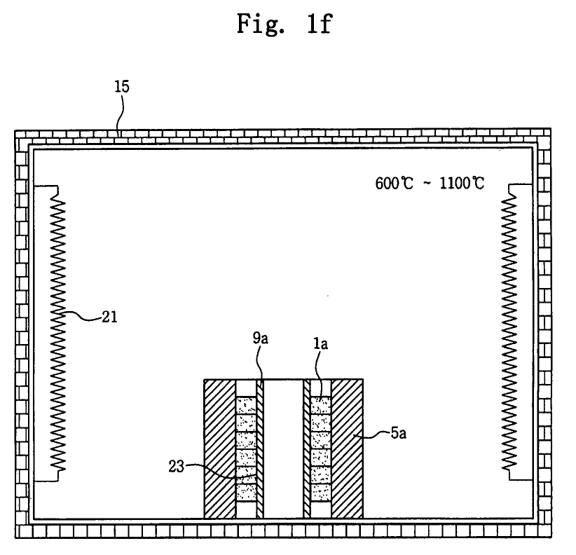

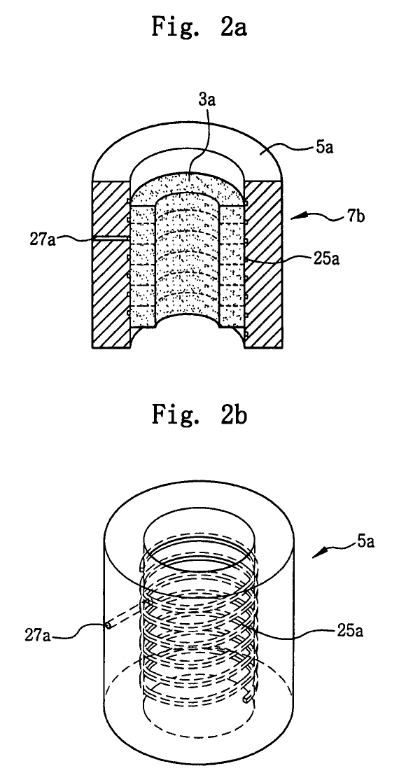

FIG. 2a and FIG. 2b are a cross-sectional view of the bush type sliding bearing according to a second embodiment of the present invention, and a perspective view of a steel base member used in the fabrication thereof.

The bush type sliding bearing according to the second embodiment of the present invention is characterized by forming at least one groove 25a on the sliding side surface of the steel base member 5a constituting the bush type sliding bearing according to the first embodiment of the present invention. Thus, it is possible to permeate the lubrication oil into the bonded surface B of the sintered segment 1a as well as into the groove 25a. Also, it is preferable to form a lubricant injection port 27a for connecting the outside with the groove 25a to facilitate the injection of the oil into the groove 25a.

### THIRD EXAMPLE

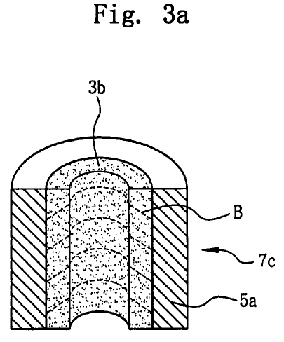

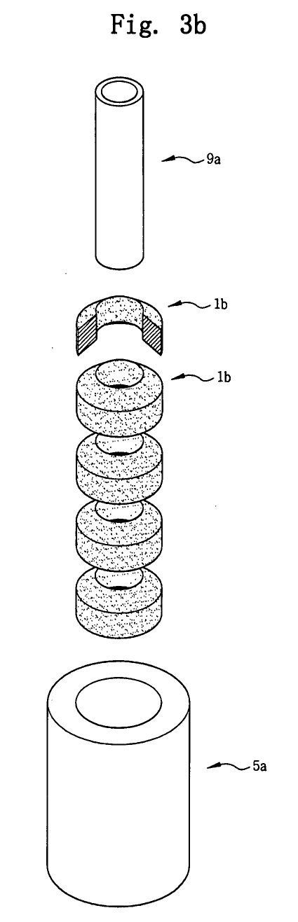

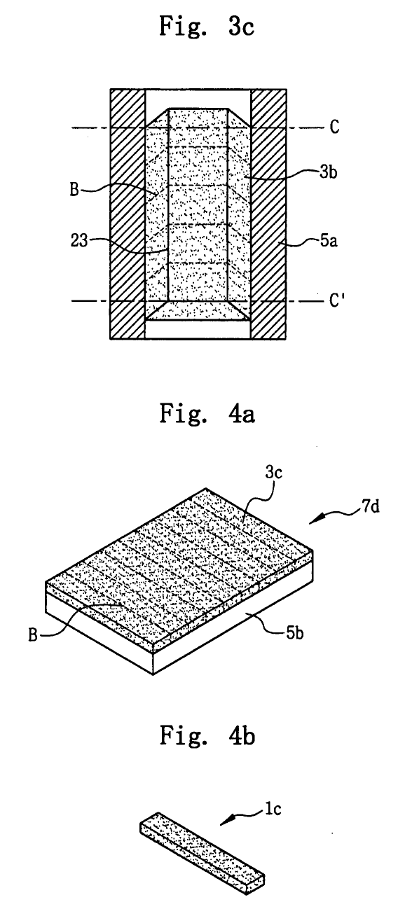

FIG. 3a through FIG. 3d show a bush type sliding bearing and a fabricating method thereof according to a third embodiment of the present invention.

The bush type sliding bearing and the fabricating method for the same according to the third embodiment of the present invention is identical with the first embodiment of the present invention that the sintered layer is formed on the sliding side surface of the cylindrical steel base member 5a by stacking a plurality of ring type sintered segments. However, it is characterized in that a bonding area is maximized by forming the bonded surface B between the respective ring type sintered segment 1b and the other ring type sintered segment 1b slant.

Thus, it is possible to permeate more volume of the lubrication oil since the area of the bonded surface B becomes large.

With regard to the bush type sliding bearing according to the third embodiment of the present invention, as shown in FIG. 3c, when the sintering-bonding process is completed in the sintering furnace, it is preferable to cut and remove the slant surface of the upper and lower sintered segments 1b. Numeral C in FIG. 3c represents a shear line. In FIG. 3a, there is shown the bush type sliding bearing fabricated by such process.

### FOURTH EXAMPLE

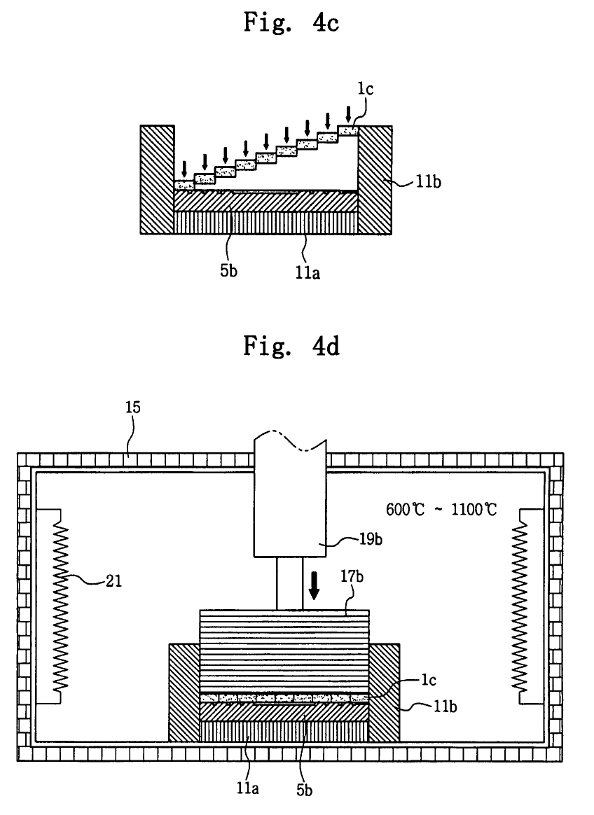

FIG. 4a through FIG. 4d show a flat board type sliding bearing and a fabricating method thereof according to a fourth embodiment of the present invention.

Referring now to FIG. 4a and FIG. 4b, the flat board type sliding bearing according to the fourth embodiment of the present invention is different from the bush type sliding bearing according to the first embodiment of the present invention that the sintered segment is formed into a small bar shape, and a flat board type steel base member 5b is used as the steel base member.

As shown in FIG. 4c, molds 11a, 11b to which the flat board type steel base members 5b are inserted, are required to forcibly compress the bar type sintered segment 1c on the sliding side surface of the steel base member.

The interval formed between the two side molds 11b is defined as an area to allow the respective sintered segment 1c to be close contacted with each other when a desired number of the bar type sintered segment 1c is inserted between inside walls of the side mold 11b. The molding material of the sintered segment and the material of the steel base member is identical with those of the bush type sliding bearing according to the first embodiment of the present invention.

As shown in FIG. 4d, the flat board type steel base member 5b is inserted into the molds 11a, 11b and a desired number of bar type sintered segments 1c is press-fitted on the sliding side surface of the flat board type steel base member 5b, and it is sintering-bonded in the sintering furnace. In this instance, the upper surface of the bar type sintered segment 1c is pressed by means of the puncher 17b disposed at the press 19b so as to accomplish good bonding between the bar type sintered segment 1c and the flat board type steel base member 5b in the course of the sintering. The sintered segment 1c is sintered secondarily together with maintaining the inside of the sintering furnace 15 to be 600° C. to 1100° C. by using the heater 21, and it is pressed with the pressure of 5 to 200 kg f/cd by using the puncher 17b disposed at the press 19b. The sintering and pressing is performed for a proper period of time between 5 to 100 minutes. In the course of this process, the whole sintered layer is formed by bonding the respective bar type sintered segments 1c to each other, and the sintered layer 3c and the steel base member 5b are integrally formed by sintering-bonding the respective bar type sintered segments 1c to the steel base member 5b. FIG. 4a shows the flat board type sliding bearing fabricated through the simultaneous secondary sintering-bonding as described above.

### FIFTH EXAMPLE

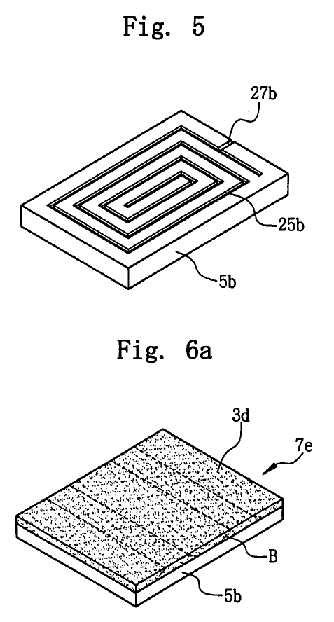

FIG. 5 is a perspective view of the steel base member used in the fabrication of the flat-board type sliding bearing according to a fifth embodiment of the present invention.

As shown in FIG. 5, it is possible to form at least one groove 25b and a lubricant injection port 27b at the flat board type steel base member 5b so that the lubrication oil can be injected through the lubricant injection port into the groove. In this regard, the pattern of the groove 25b can be diversely formed and is not restricted.

### SIXTH EXAMPLE

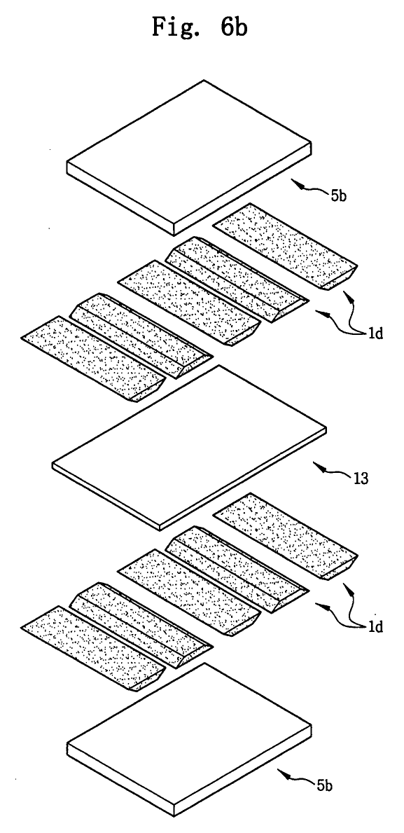

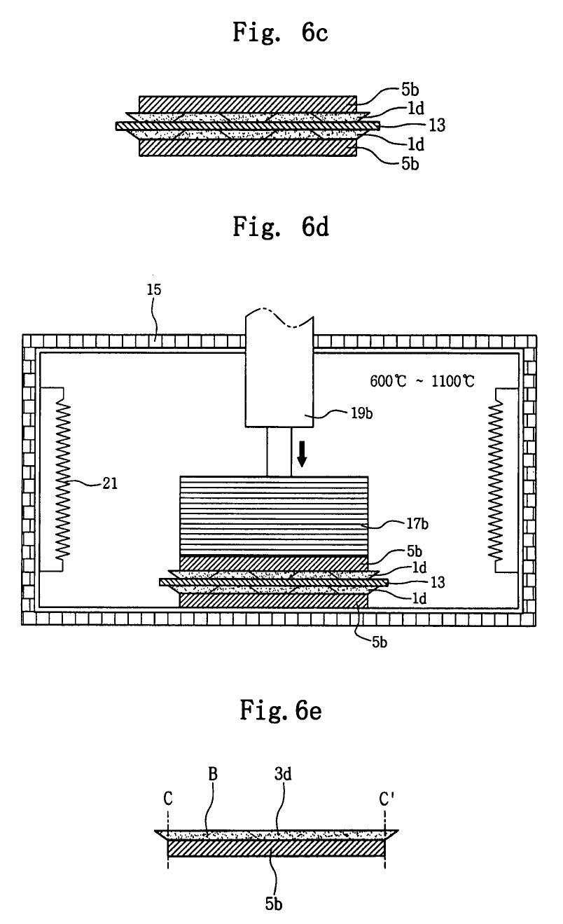

FIG. 6a through FIG. 6e show a flat board type sliding bearing and a fabricating method thereof according to a sixth embodiment of the present invention.

The flat board type sliding bearing according to the sixth embodiment of the present invention is the same as the flat board type sliding bearing according to the fourth embodiment of the present invention that the sintered layer is formed by stacking a plurality of bar type sintered segments on the sliding side surface of the flat board type steel base member 5b in the horizontal direction, however, it is different form the flat board type sliding bearing according to the fourth embodiment of the present invention that the bonding area is maximized by forming the bonded surface B formed between the respective sintered segment slant.

Referring to FIG. 6b and FIG. 6c, the steel base member 5b and the bar type sintered segment with slant sides are stacked as a double layer and a partition board 13 is inserted there-between to sinter two or more than two flat board type sliding bearings incidentally by the sintering and compression all at once. In other words, it is stacked in sequence as, a flat board type steel base member 5b→a sintered segment 1d assembly→a partition board 13→a sintered segment 1d assembly→a flat board type steel base member 5b.

While FIG. 6b through FIG. 6d show illustratively a case of stacking the steel base member 5b and the sintered segment 1d as a double layer, it is also possible to stack them to be more than three layers so that a plurality of sliding bearings can be sintering-bonded all at once. In this instance, the release agent as described above can be applied on both surfaces of the partition board 13. The release agent is required to easily separate the partition board 13 from the sintered segment id after the sintering-bonding process.

The sintering-bonding between the bar type sintered segments 1d and the sintering-bonding between the bar type sintered segment 1d and the sliding side surface of the flat board type steel base member 5b are performed in the sintering furnace with the pressurizing of the puncher 17b and the press 19b. The sintering condition is the same as that of the fourth embodiment.

Referring to FIG. 6e, when the sintering is completed, the post-work for cutting and removing the outside portion of the cut lines C, C′ is completed to thereby obtain the flat board type sliding bearing by using the sintered segment formed with slant bonded surface as shown in FIG. 1a.

As described above, according to the present invention, it is possible to provide a sliding bearing, in which the whole sintered metal structure of the sintered layer is dense and uniform, when the sintered layer having a big size (volume, length of the lubrication surface, area of the lubrication surface) is formed on the steel base member.

Also, it is possible to provide a sliding bearing having a good precision degree of the size and shape of the sintered layer, even if the sintered layer having a big size is formed on the steel base member, and increase the permeation amount of the lubrication oil.

In addition, it is possible to produce a sliding bearing, which can quickly and easily cope with the various size requirements instantly at low production cost.

While the present invention has been described with reference to the particular preferred embodiments, it is not to be restricted by the embodiments but only by the appended claims.

Also, it is to be appreciated that those skilled in the art can change or modify the embodiments without departing from the scope and spirit of the present invention, and such modifications are wholly pertained to scope of the appending claims.

1. A sliding bearing having a sintered layer formed of sintered segments on a sliding side surface of a steel base member, the sintered layer being made of iron group metal powder and solid lubricant and being formed by forcibly compressing the sintered segments, each of which is molded by previously sintering mixtures made of the iron group metal powder and the solid lubricant into a size enough to construct a portion of the whole sintered layer, on the sliding side surface of the steel base member to form the whole sintered layer, and sintering-bonding the sintered segments to each other and also each of the sintered segments to the steel base member.

2. The sliding bearing according to claim 1, wherein the steel base member is constructed of a cylindrical steel base member formed with the sintered layer by using a ring type sintered segment, or a flat board type steel base member formed with the sintered layer by using a bar type sintered segment.

3. The sliding bearing according to claim 1, wherein at least one groove is formed on the sliding side surface of the steel base member to enable the lubrication oil to be injected therethrough.

4. The sliding bearing according to claim 1, wherein a bonded surface of the sintered segment is formed slantly.

5. The sliding bearing according to claim 2, wherein at least one groove is formed on the sliding side surface of the steel base member to enable the lubrication oil to be injected therethrough.

6. The sliding bearing according to claim 2, wherein a bonded surface of the sintered segment is formed slantly.
